(19) United States
(12) Patent Application Publication
(10) Pub. No.: US 2003/0015380 A1
(43) Pub. Date: Jan. 23, 2003

(54) Brake actuator with one-piece take-up reel

(75) Inventors: Michael Sykes, Ontario (CA); Steven Demoe, Leaksdale (CA); Bob Bunker, Orillia (CA)

Correspondence Address: PILLSBURY WINTHROP, LLP, P.O. BOX 10500, MCLEAN, VA, 22102, US

(73) Assignee: VENTRA GROUP INC., Bradford (CA)

(21) Appl. No.: 10/146,145

(22) Filed: May 16, 2002

Related U.S. Application Data
(60) Provisional application No. 60/291,334, filed on May 17, 2001.

(51) Int. Cl. F16D 55/02

(52) U.S. Cl. 188/2 D; 188/72.9; 188/71.9

(57) ABSTRACT

The present application discloses a brake actuator for applying tension to a brake cable. The actuator includes: a mounting bracket; a brake actuator lever mounted for pivotal movement relative to the mounting bracket in brake applying and brake releasing directions; and a cam-and-drum member mounted for rotation relative to relative to the brake actuator lever. The cam-and-drum member is formed as one integral part including a protruding drum portion and a cam portion integral with the drum portion. The present application also discloses a brake actuator with a one-piece cam member.

The present application claims priority to U.S. Provisional Application Ser. No. 60/291,334, the entirety of which is hereby incorporated into the present application by reference.

### FIELD OF THE INVENTION

The present invention relates to brake actuators.

### BACKGROUND OF THE INVENTION

There is an ever-present pressure in the automotive industry to lower costs, both with respect to the overall cost of the vehicle, and the various parts and components used in the vehicle. With respect to brake actuators, these devices are found in many vehicles, but their design is relatively complex, which leads to relatively high costs. The present invention endeavors to provide improvements to a brake actuator that enable part count and manufacturing complexity to be reduced relative to known brake actuators.

### SUMMARY OF THE INVENTION

One aspect of the present invention provides a brake actuator for applying tension to a brake cable connected to the brake system of a motor vehicle. The actuator of this aspect of the invention comprises: a mounting bracket; a brake actuator lever mounted for pivotal movement relative to the mounting bracket in brake applying and brake releasing directions; and a cam-and-drum member mounted for rotation relative to relative to the brake actuator lever. The cam-and-drum member is formed as one integral part including a protruding drum portion and a cam portion integral with the drum portion. The cam portion provides a groove defining a cable guide for receiving the brake cable and enabling winding thereof onto the cam portion. A clutch releasably couples the cam-and-drum member to the brake actuator lever such that the cam-and-drum member rotates with pivotal movement of the brake actuator lever relative to the mounting bracket at least in a brake applying direction, thereby winding the brake cable onto the cam portion and applying tension to the cable for activating the brake system. The clutch is operable to release the cam-and-drum member from the lever such that the cam-and-drum member is able to rotate relative to the brake actuator lever at least when the lever is in a brake released position. A spring is connected to the cam-and-drum member and biases the cam-and-drum member in a slack take-up direction relative to the lever to wind the cable thereon for taking up cable slack when the clutch releases the cam-and-drum member from the lever.

Another aspect of the present invention also provides a brake actuator for applying tension to a brake cable connected to the brake system of a motor vehicle. The actuator comprises: a mounting bracket; a brake actuator lever mounted for pivotal movement relative to the mounting bracket; and a cam member mounted for rotation relative to relative to the brake actuator lever. The cam member provides a groove defining a cable guide for receiving the brake cable and enabling winding thereof onto the cam member. The cam member is formed as one integral part. A clutch releasably couples the cam member to the brake actuator lever such that the cam member rotates with pivotal movement of the brake actuator lever relative to the mounting bracket at least in a brake applying direction relative to the mounting bracket, thereby winding the brake cable onto the cam member and applying tension to the cable for activating the brake system. The clutch is operable to release the cam member from the lever such that the cam member is able to rotate relative to the brake actuator lever at least when the lever is in a brake released position. A spring is connected to the cam member, either directly or indirectly via an intervening structure. The spring biases the cam member in a slack take-up direction relative to the lever to wind the cable thereon for taking up cable slack when the clutch releases the cam member from the lever.

Other objects, features and advantages of the present invention will be appreciated by the following detailed description, the accompanying drawings and the appended claims.

### BRIEF DESCRIPTION OF THE DRAWINGS

For a better understanding of the present invention and to show more clearly how it may be carried into effect, reference will be made by way of example to the accompanying drawings, in which:

FIG. 1 is an isometric view, from the rear and to one side, of a prior art parking brake actuator;

FIG. 2 is an exploded isometric view of the actuator of FIG. 1;

FIG. 3 is a side view of the actuator of FIG. 1, showing the other side thereof;

FIG. 4 is a cross-sectional schematic side view of the actuator of FIG. 1, showing the position lock assembly elements in isolation;

FIG. 5 is a second cross-sectional schematic side view of the actuator of FIG. 1, showing the self-adjust assembly elements in isolation;

FIG. 6 is a cross-sectional view of the actuator of FIG. 1, taken along the line 6-6 in FIG. 3;

FIG. 7 is a side view of the self-adjust assembly, shown in the brake-released position;

FIG. 8 is a side view of the self-adjust assembly, shown in a brake-applied position;

FIG. 9 is a chart plotting the mechanical advantage against cable travel;

FIG. 10 is a perspective view of a one-piece take-up reel or cam in accordance with an aspect of the present invention;

FIG. 11 is an exploded perspective view of a brake actuator incorporating a one-piece take-up reel and drum in accordance with another aspect of the invention;

FIG. 12 is a perspective view of the one-piece take-up reel and drum in the actuator of FIG. 11; and

FIG. 13 is a perspective view of the take-up reel and drum in FIG. 12, taken from the opposite side thereof.

### DETAILED DESCRIPTION OF THE ILLUSTRATED EMBODIMENT

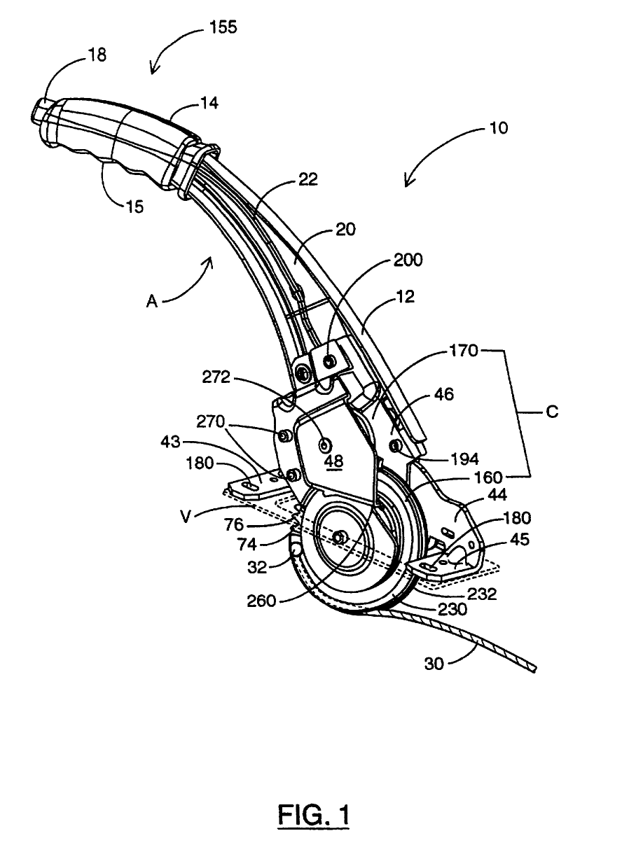

A prior art self-adjusting parking brake actuator is shown generally in the FIGS. 1-9 at 10. The actuator 10 is shown and described herein in a hand-operated embodiment; however, one skilled in the art will appreciate that the present invention is easily adaptable to a foot-operated configuration (not shown) and, thus such adaptation need not be discussed further in this description. This prior art construction is being described to illustrate an exemplary context for the invention and should not be considered limiting in any way.

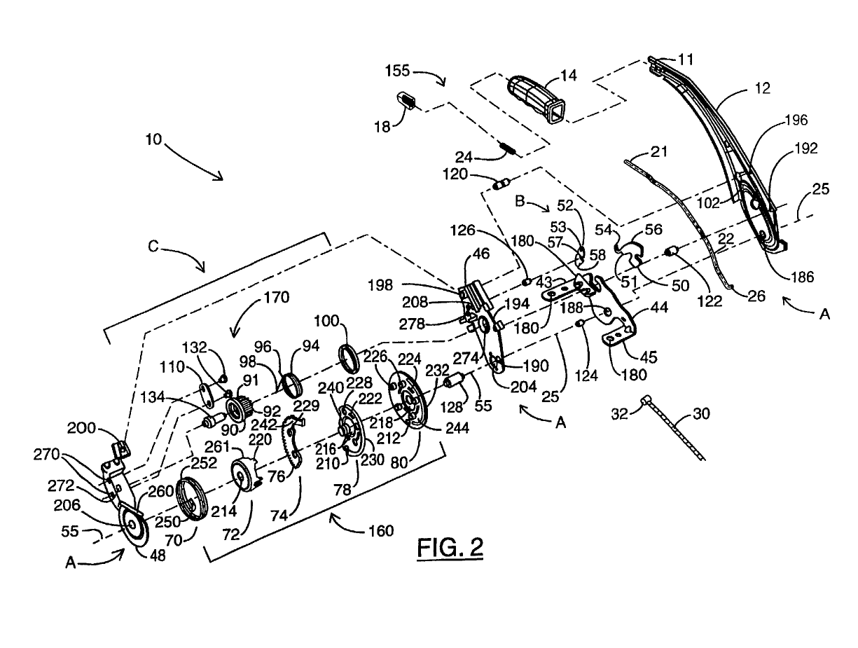

Referring to FIGS. 1 and 2, actuator 10 comprises a brake actuator lever assembly A, a position locking assembly B, and a tension self-adjust assembly C having a self-adjusting cam subassembly 160 and a clutch subassembly 170. A brake cable 30 is connectable to self-adjust assembly C, as will be described below.

Lever assembly A comprises a lever handle 12, an intermediate plate 46 and a cover plate 48 connected by a rivet 120 positioned through holes 196, 198, and 200, respectively. Lever 12 and intermediate plate 46 are also joined by a rivet 122, via holes 192 and 194, and by a pivot rivet 124, through holes 186 and 190. Intermediate plate 46 and cover plate 48 are also joined by a cam rivet 128, through holes 204 and 206, and a pinion rivet 134, through holes 272 and 274. Pivot rivet 124, cam rivet 128 and pinion rivet 134 also have other functions which are described in more detail below.

Lever 12 has a free end 11 having a hand grip 14 to facilitate the grasping of lever 12 by the vehicle operator. An undulating surface 15 on grip 14 is provided for the operator's comfort and increased control. Lever assembly A is rotatably mounted on a mounting bracket 44, for rotation about a fulcrum or lever axis 25 defined by pivot rivet 124 positioned through holes 186, 188, and 190 in lever 12, mounting bracket 44, and intermediate plate 46, respectively. The lever assembly A moves in opposing brake applying and releasing directions.

Mounting bracket 44 has lugs 43 and 45 for connection in any suitable manner to a motor vehicle body V, via holes 180. Brake cable 30 may be of any type and construction known in the art.

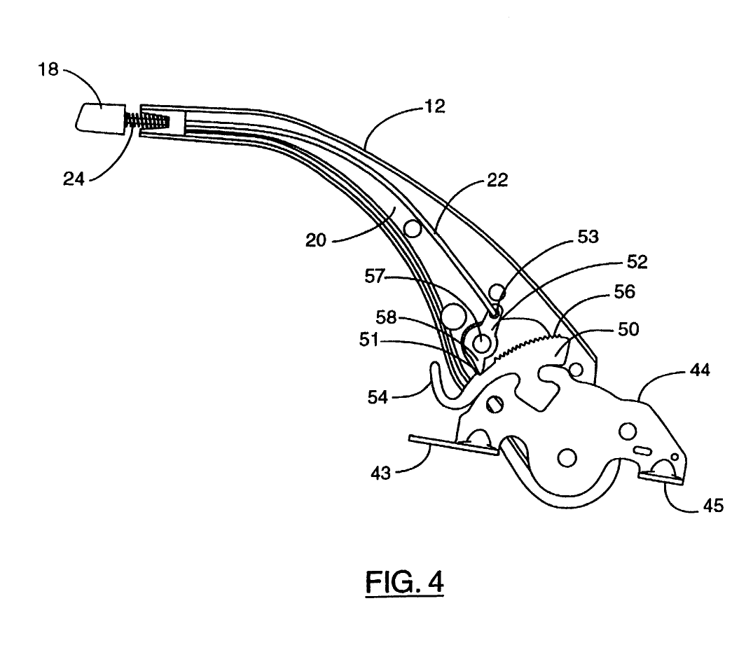

Position lock assembly B comprises a pawl subassembly 150 and a pawl release subassembly 155. Pawl subassembly 150 comprises a ratchet sector 50, having a shoulder 51 and teeth 56, and a pawl 52, having a nose 58 for engagement with teeth 56, as will be described below. Ratchet 50 also comprises a finger 54 (see also FIG. 4) for actuating clutch subassembly 170, as will be described further below. Ratchet 50 is fixedly mounted on mounting bracket 44. Pawl 52 is pivotably mounted between lever handle 12 and intermediate plate 46 by a pawl rivet 126 positioned through holes 57, 102 and 208. Pawl 52 is positioned on lever assembly A such that, as lever assembly A is rotated about lever axis 25, nose 58 of pawl 52 is continuously capable of operative engagement with teeth 56 on ratchet 50, as will be understood by one skilled in the art. Any suitable mechanism may be used in place of the pawl mechanism.

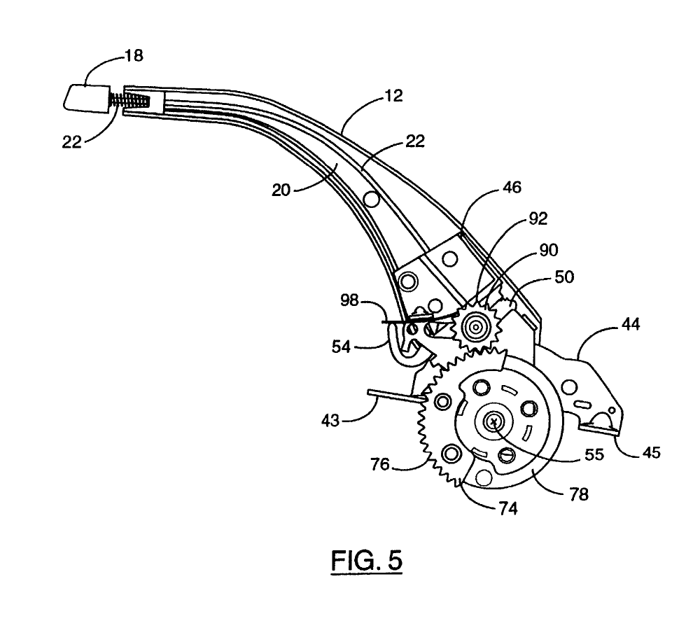

Release subassembly 155 comprises a push button 18 operatively connected to a rod 22 having ends 21 and 26. Rod 22 is substantially rigid and positioned longitudinally in an interior space 20 of lever 12. Rod end 21 is positioned adjacent lever free end 11 and cooperates with a push button 18 and a release spring 24 (see FIGS. 4 and 5). Push button member 18 is slidably and depressibly located in grip 14, with release spring 24 outwardly biasing push button 18. Rod end 26 is connected to pawl 52 at a guide slot 53, on an opposite side of a pawl pivot 57 from nose 58. Spring 24 also biases rod 22 away from pawl subassembly 150 (ie. spring 24 simultaneously pushes button 18 away from lever end 11 and pulls rod 22 towards lever end 11), and thereby biases guide slot 53 away from ratchet 50, causing nose 58 to be pivotably biased towards ratchet 50 to selectively maintain biased contact therewith.

Self-adjust assembly C, which comprises self-adjusting cam subassembly 160 and clutch subassembly 170, is mounted to lever assembly A between intermediate plate 46 and cover plate 48, as will be described further below.

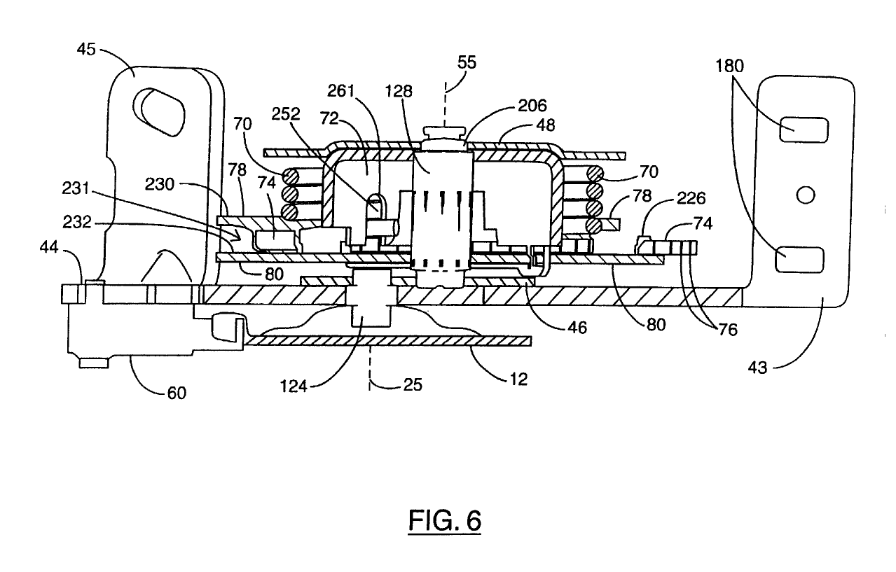

Referring to FIGS. 2 and 6, self-adjusting cam subassembly 160 comprises a drum 72, an inner cam 78, an outer cam 80, a cam sector 74 having a plurality of engagement teeth 76, and a helical self-adjust spring 70. The inner and outer cams 78 and 80 together constitute a cam with a groove or trough for receiving and winding up the cable 30 therein, and may also be referred to as a take-up reel. Cam sector 76, outer cam 78 and inner cam 80 are secured to one another by bosses 226 upset in holes 228 and 229. Drum 72, inner cam 78 and outer cam 80 are secured together through the cooperation of tabs 220 and slots 222 and 224. Cam subassembly 160 is rotatably mounted to lever assembly A between cover plate 48 and intermediate plate 46 by cam rivet 128, mounted in holes 204 and 206, respectively, and passing through holes, 214, 216, and 218, respectively. Intermediate plate 46 thus positions cam subassembly 160 axially adjacent to lever 12. Cam rivet 128 provides a cam axis 55 for the rotation of cam subassembly 160 therearound, as described further below. The drum 72 functions to occupy the distance between the cam and the cover plate 48 so as to provide lateral support for the cam and also maintain suitable distance for the various internal components of the actuator 10.

Referring briefly to FIGS. 6, 7 and 8, cam axis 55 is parallel to, and offset from, lever axis 25. The offset amount, indicated by reference letter “e” in the Figures, is less than the outer radius “r” of cam subassembly 160, as will be described in more detail below.

Referring again to FIGS. 2 and 6, spring 70, having an outer tang 250 and an inner tang 252, is positioned between cam subassembly 160 and lever assembly A and preferably between cam subassembly 160 and cover plate 48. Self-adjust spring 70 is mounted around drum 72, with outer tang 250 fixed to cover plate 48, by engagement of slot 260 therewith, and inner tang 252 inserted into a retention slot 261 in drum 72. The self-adjust spring 70 is installed in a pre-stressed state so as to bias the self-adjusting cam subassembly 160 in the ‘brake-apply’ direction, for reasons described in more detail below. This may also be referred to as a slack take-up direction, as in certain instances the cam will rotate independently of the lever to take-up cable slack, and thus will not actually be applying the brakes. Since spring 70 is provided prior to installation in a prestressed state, suitable caging means for cam subassembly 160 may be provided.

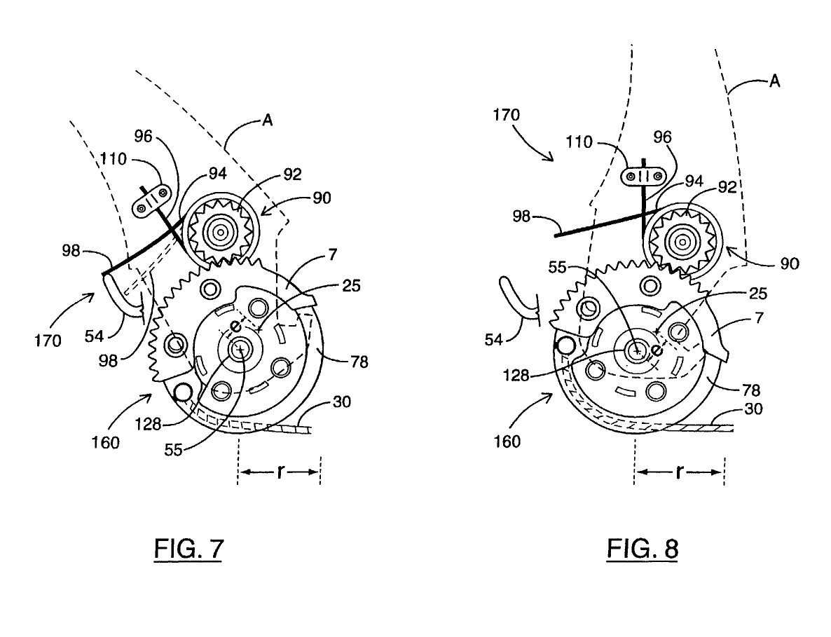

Cam subassembly 160 has slots 210 and 212 for receiving a cable head 32, positioned on the actuator end of brake cable 30, for connecting brake cable 30 to cam subassembly 160. Outer cam 78 and inner cam 80 have flanges 230 and 232, respectively, which cooperate to form a cable guide 231 for ensuring an orderly peripheral positioning of cable 30 around cam subassembly 160, as cam subassembly 160 is rotated in the brake-apply or slack take-up direction (as seen in FIGS. 7 and 8 and described further below).

Referring again to FIG. 2, clutch subassembly 170 comprises a pinion 90, having a hub 91 and teeth 92, and a helical clutch spring 94 wrapped around hub 91. Pinion 90 is rotatably mounted to lever assembly A, preferably between cover plate 48 and intermediate plate 46 by pinion rivet 134 extending between holes 272 and 274, restively. Spring 94 is positioned on hub 91 such that an embracing friction occurs therebetween, permitting the windings of spring 94 to securely grip hub 91. A pinion spacer ring 100 is preferably provided to impede interference between clutch spring 94 and teeth 92. Teeth 92 operatively engage teeth 76 of cam sector gear 74. Clutch spring 94 has tangs 96 and 98.

Referring to FIGS. 7 and 8, tang 96 is fixed to cover plate 48 by an anchor clip 110 held by a pair of anchor rivets 132 in holes 270. Tang 98, however, remains free for selectively tabbing thereof by finger 54, which constitutes a clutch spring release, as will be described in more detail below.

As will be understood by one skilled in the art, spring 94 is oriented on hub 91 of pinion 90 such that rotation of pinion 90 in a clockwise direction (with reference to FIGS. 5, 7, 8) tends to wind spring 94 more tightly around hub 91, through the frictional contact of hub 91 and spring 94. Further, it will be understood by one skilled in the art that, while spring 94 may be fabricated from stock having a rounded cross-section, a rectangular cross-section spring is desired to increase the contact surface area between spring 94 and hub 91, thereby increasing the gripping ability of spring 94. Also, it will be understood by one skilled in the art that the friction between spring 94 and hub 91 is be sufficient to permit clutch subassembly 170 to resist counter-rotation of cam subassembly 160, in response to an induced tension in cable 30 such that, when lever assembly A is moved from the ‘brake-released’ to ‘brake-applied’ positions, clutch subassembly 170 locks cam subassembly 160 sufficiently so that cam subassembly 160 rotates with lever assembly A without slipping. Finally, it will be understood that the interference fit of spring 94 must also be loose enough so that, when free tang 98 is tabbed by finger 54 when actuator 10 is in the ‘brake-released’ position (as will be described below), pinion 90 is permitted to ‘free-wheel’ within spring 94, thereby unlocking cam subassembly 160 from lever assembly A.

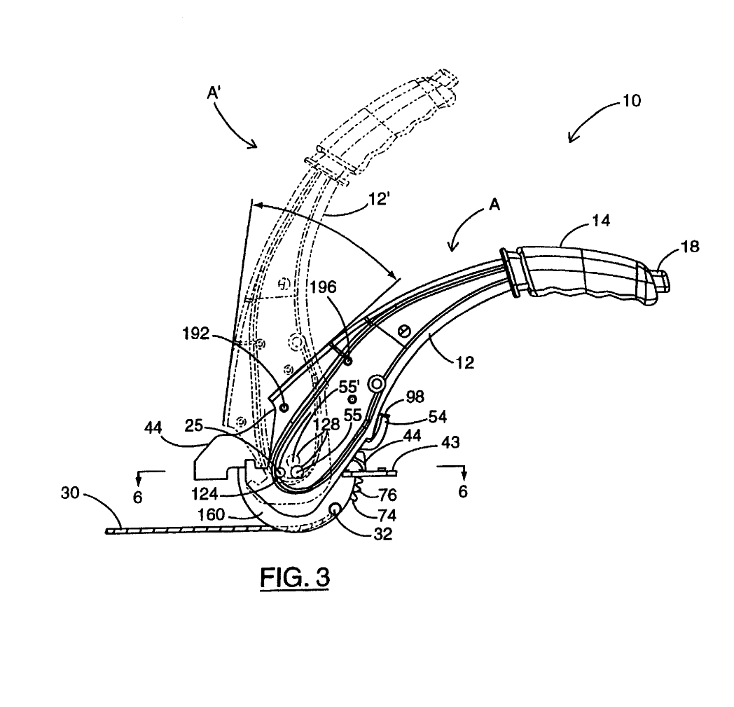

Referring to FIG. 3, in use actuator 10 is operated by selectively positioning lever assembly A in either the ‘brake-released’ position (shown in solid lines) or one of a plurality of ‘brake-applied’ positions (one such position shown in stippled lines at 12′). As indicated above, lever assembly A rotates about lever axis 25, by manipulation of lever 12 by the vehicle operator.

Referring to FIG. 7, when actuator 10 is in the ‘brake-released’ position, lever assembly A is positioned relative to mounting bracket 44 such that finger 54 engages free tang 98 of spring 94, thereby slightly unwinding spring 94 and allowing pinion 90 to rotate freely about pinion rivet 134, thus disengaging clutch subassembly 170. As a result, the self-adjusting cam subassembly 160, having sector teeth 76 engaged with pinion teeth 92, is “unlocked” relative to lever assembly A and capable of rotation in response to self-adjust spring 70. Any slack which may be present in cable 30, such as slack introduced during installation or introduced over time by casual cable stretch, is thus automatically taken up by a rotation of cam subassembly 160 in the ‘brake-apply’ direction (clockwise in FIG. 7) when the actuator is in the ‘brake-released’ position. Spring 70 is sized and of sufficient strength to provide a desired minimum residual tension in cable 30 but not otherwise cause an unintentional application of the vehicle parking brakes.

Also, referring to FIG. 4, when actuator 10 is in the ‘brake-released’ position, position locking assembly B maintains nose 58 in contact with sector 50, adjacent untoothed shoulder 51 and, thus out of engagement with teeth 56.

Referring to FIG. 8, when lever assembly A is rotated out of the ‘brake-released’ position to a ‘brake-applied’ position, the rotation of lever assembly A moves clutch subassembly 170 away from finger 54, causing finger 54 to release tang 98 and permitting clutch spring 94 to contract and thereby tightly grasp or embrace pinion 90. As described above, since tang 96 of clutch spring 94 is anchored to cover plate 48 (i.e. part of lever assembly A), spring 94 cannot rotate and, thus, pinion 90 is thus not permitted to rotate, particularly in the clockwise direction (as viewed in FIGS. 7, 8). Cam subassembly 160 is thus “locked” to lever assembly A through the co-action of pinion teeth 92 and sector 74. The rotation of lever assembly A in ‘brake-apply’ direction tends to further wind the clutch spring 94 around hub 91, thereby increasingly prohibiting rotation of pinion 90. As a result of the ‘locked’ condition, pinion 90 is unable to rotate and an operative locked connection is established between the lever assembly A and the self-adjusting cam subassembly 160. As lever assembly A is rotated towards a ‘brake-apply’ position, cam subassembly 160 thus also rotates, around lever axis 25 due to the eccentric mounting of cam subassembly 160, and cable 30 is rotated clockwise (see FIG. 8) about lever pivot 25 to increasingly tension and take up cable to apply the parking brake system.

Also, as lever assembly A is advanced in the ‘brake-apply’ direction, pawl 52 is rotated about lever axis 25 to permit nose 58 to come into contact with teeth 56 of sector 50. The angle of teeth 56 of sector 50 relative to nose 58 of pawl 52 permits nose 58 to advance over teeth 56 without depressing button 18 of pawl release subassembly 155. Thus, the vehicle operator may simply rotate lever 12, although button 18 may be depressed if desired, once nose 58 has advanced from shoulder 51 to engage teeth 56, pawl subassembly 150 will act to prevent the reverse rotation of lever 12 in the ‘brake-release’ direction (i.e. clockwise in FIG. 4). Lever 12 is advanced in the ‘brake-apply’ direction, thereby tensioning cable 30, until a desired lever of brake cable tension is achieved to set the vehicle parking brakes sufficiently to the operator's satisfaction. The lever may have an operable rotation range of about 40 degrees, for example. To release the brakes, button 18 is depressed to release nose 58 from teeth 56 for such rotation. When button 18 is depressed, pawl nose 58 rotates about the pawl pivot 57 to disengage nose 58 from sector teeth 56. Lever 12 may then be rotated, while button 18 is depressed, back to the ‘brake-released’ position.

By providing an eccentric positioning of cam axes 55 relative to lever axis 25, the actuator achieves a variable mechanical advantage as the actuator lever is stroked to full position. Thus, the amount of operator input force necessary to apply the parking brake throughout the lever stroke is reduced. Also, advantageously, the overall lever length can be reduced. For example, an eccentric offset “e” of 15 mm results in a significant increase in the maximum mechanical advantage achievable for an actuator given size.

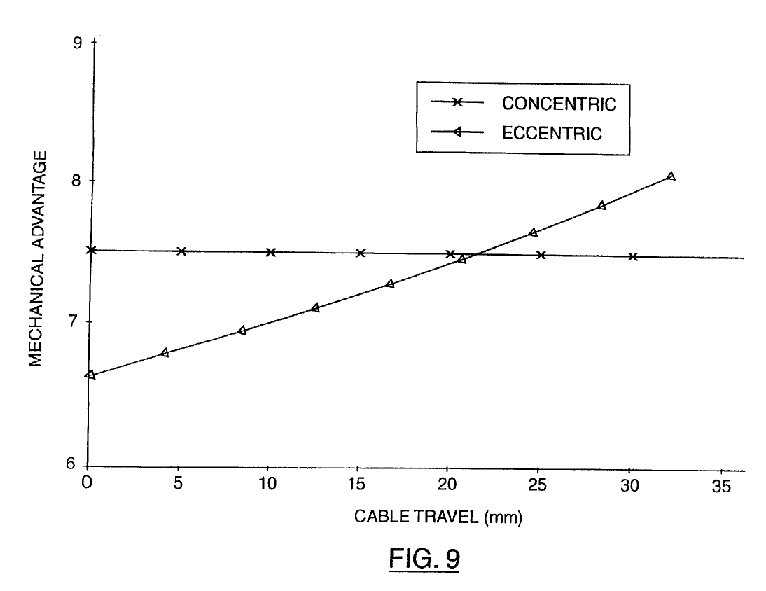

The benefits of the illustrated actuator, in terms of available mechanical advantage per a given amount of cable travel, is shown in FIG. 9. The “Eccentric” line of FIG. 9 represents an actuator according to the present invention having a 350 mm lever, 45 mm radius cam and a 15 mm offset between the cam and lever axes. Also shown in FIG. 9, for comparison purposes, is a comparably-sized (in terms environmental space requirements) concentric actuator (“Concentric” v line). The “Eccentric” line clearly demonstrates that a small eccentric mounting yields a marked benefit, in terms of mechanical advantage, over a comparably-sized concentric design.

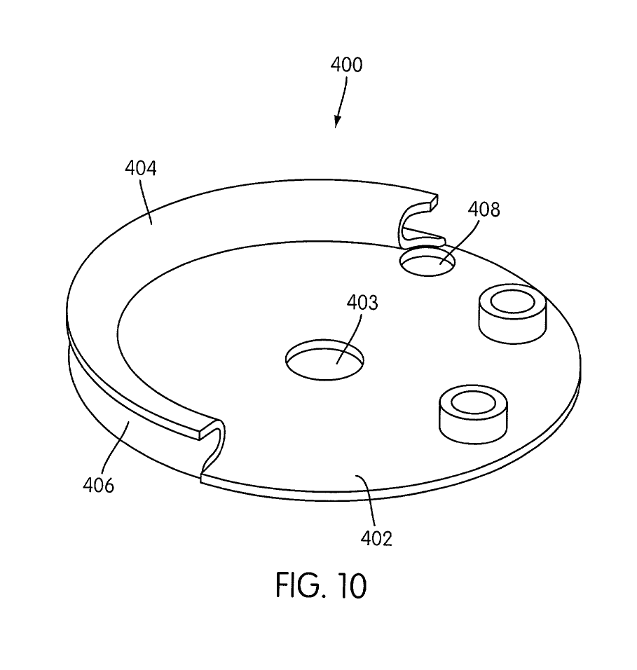

Turning now to FIG. 10, it illustrates a one-piece take-up reel or cam 400. The cam 400 may be used in the prior art construction discussed above, or any other type of brake actuator. The cam 400 includes a generally circular disc-shaped body 402. The body 402 has a central opening 403 for mounting to the pivot rivet 128 in the above-described construction. Slots may be formed as in cam portions 78 and 80 for mounting a separately formed drum thereto. The peripheral edge of the body 400 has an integrally formed flange 404 that is bent into a trough or U-shape to define a groove 406 to act as a cable guide. An aperture 408 is provided for receiving a cable head, such as cable head 32.

The body 402 is formed by a progressive stamping operation from a piece of suitable gauge sheet metal, such as steel. Specifically, the body 402 is initially stamped to form its general shape along with flange 404, hole 403, aperture 408, and any other slots or holes, such as for mounting a drum, such as drum 72. The body is further stamped in a subsequent die to bend the flange 404 generally perpendicularly to the body 400; however, the bending of the flange may be done in the same stamping as the formation of the cam body 402. The free end of the flange 404 is then deformed further to bend it over to create the U-shape and define the groove 406. The deforming of the free end of the flange 408 is preferably done by a subsequent stamping die. One skilled in the art can readily appreciate the particular die shapes required to form the cam member 400 as illustrated, and thus detailed illustrations of the particular stamping dies are not being provided. Other methods of forming these structures may also be used.

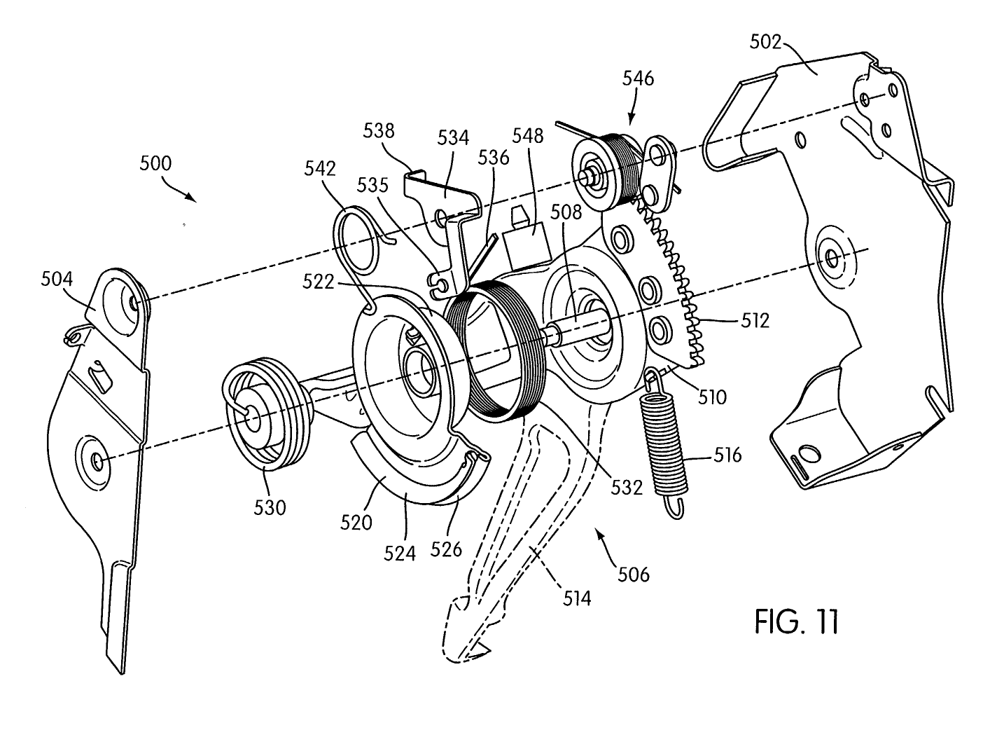

FIG. 11 shows a foot-operated type brake actuator 500. The actuator 500 includes a mounting bracket 502 for mounting the actuator 500 within the passenger compartment of a vehicle, usually beneath the driver's side of the dashboard. A pedal lever 506 is pivotally mounted to the bracket 502 on a pivot rivet 508 and a cover plate 504 is fixedly mounted to the lever 506 opposite the bracket 502. The lever 506 includes a body portion 510 having an arcuate sector 512 thereon and a lever arm 514 fixed to the body portion 510. In the Figure, the brake apply direction is counterclockwise, and a spring 516 is connected between the lever 506 and the bracket 502 to bias the lever in the brake releasing direction (clockwise in FIG. 11) opposite the brake applying direction (counterclockwise). This ensures that the lever 506 is returned to the full released position in the event there is insufficient cable tension to pull it to that position.

A one-piece cam-and-drum member 520 is rotatably mounted to the lever 506 about the pivot rivet 508. The member 520 is formed as one integral part including a protruding drum portion 522 and a cam or take-up reel portion 524 integral with the drum portion 522. The cam portion 524 provides a groove 526 defining a cable guide for receiving the brake cable 30 and enabling winding thereof onto the cam portion 524. This manner in which this component is formed will be described in further detail hereinbelow.

A take-up spring 530 is mounted within the hollow of the drum portion 522 and has one end connected to the cover plate 504 and another end connected to the drum portion 522, or some other portion of the cam-and-drum member 520. The spring 530 rotatably biases the cam-and-drum member 520 in a slack take-up direction (which is the same as the brake applying direction) relative to said lever to wind the cable thereon for taking up cable slack in a manner which is described hereinbelow.

A clutch spring 532 embraces an exterior surface of the drum portion 522 and is connected to the lever 506 to releasably couple said cam-and-drum member 520 to said brake actuator lever 506. Generally, the clutch spring operates much in the way described above. One end of the clutch is fixed to the lever 506 and the other end 536 is free. Normally, as the brake lever 506 is being moved in the brake applying direction, the spring 532 remains contracted to frictionally embrace the exterior surface of the drum portion 522. This frictional engagement, together with an end of the spring 532 being fixed to the lever 506, couples the cam-and-drum member 520 to the lever 506 so that the move together, thus enabling tension to be applied to the brake cable for purposes of activating the brake system of the vehicle. When the lever 506 is returned to its brake released position, the free end 536 of the spring 532 engages a tab or other surface on the bracket 502 so that the spring 532 is expanded. The decouples the cam-and-drum member 520 from the lever 506 so that the take-up spring 530 can take-up and slack in the brake cable and ensure it has proper tension. Upon movement of the lever 506 in the brake applying direction, the slight friction between the spring 532 and the drum portion 522 will cause the cam-and-drum member 520 to rotate sufficiently to disengage the free end 536 from the bracket, whereby the spring 532 again contracts as discussed above.

A torsion clutch assembly 546 has the same general construction and functions in the same way as clutch subassembly 170 discussed above, with the following exceptions. In the embodiment of FIG. 11, the clutch assembly 170 engages the sector 512 on the lever 506 to prevent it from being moved in the brake releasing direction, but functions in a one-way manner to enable the lever to be moved in a brake-applying direction. A clutch release lever 534 is pivotally mounted to the bracket 502 and has a spring receiving portion 535 for retaining a free end torsion clutch spring in the clutch assembly 546. The lever 534 is connected to a manual release handle (not shown) by which operation of the handle pivots the lever 534. This movement in turn moves the free end of the torsion clutch spring in the clutch assembly, which in turn expands the clutch spring and enables a pinion gear of the assembly 546 to freely rotate. This enables the tension of the brake cable to pull the lever and cam-and-drum member 520 back in the brake releasing direction.

A contact switch 548 is provided on the lever 506 and engages the bracket 504 when the brake lever 506 is in the fully released position. This can be used to send a signal to turn off an indicator light in the passenger compartment indicating that the brake has been applied.

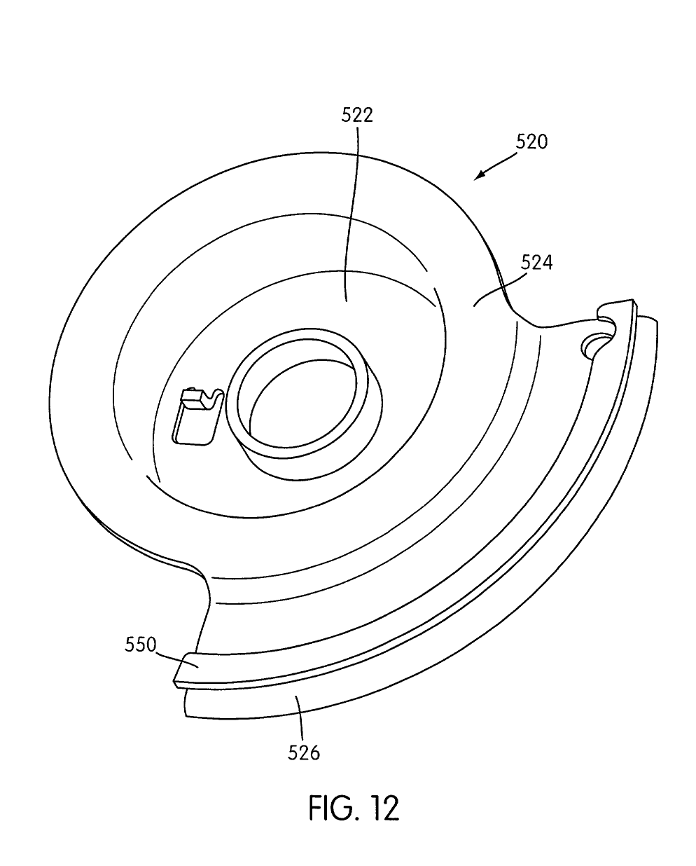

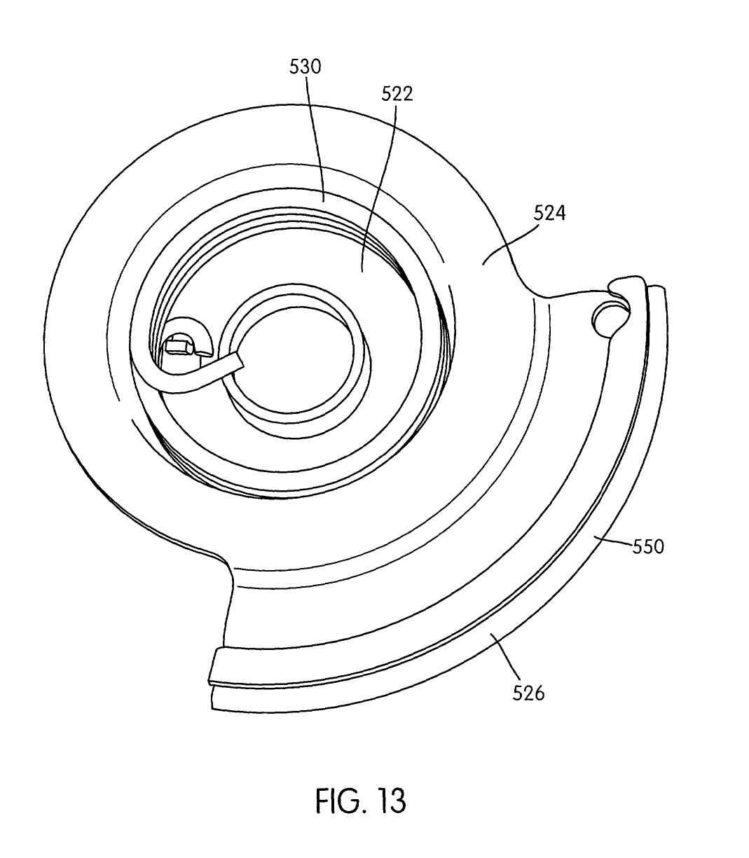

Referring more specifically to the cam-and-drum member 520, as illustrated in FIGS. 12 and 13, the cam-and-drum member 520 is formed in a similar fashion to the one-piece cam 400 described above, with the exception that the drum portion 522 is formed integral with the cam portion 524. Specifically, member 520 is formed by a progressive stamping operation from a piece of sheet metal, such as steel. The member 520 is initially stamped to form its general shape, including the drum portion 522 and the general disc-shape of the cam portion 524. This may be done in a single stamping operation, or in multiple operations. A flange 550 is formed along the edge of the cam portion 524. This flange 550 further stamped in a subsequent die to bend the flange 550 at an angle, preferably generally perpendicularly, to the body; however, the bending of the flange 550 may be done in the same stamping as the formation of the cam portion 524. The free end of the flange 550 is then deformed further to bend it over to create the U-shape and define the groove 526. The deforming of the free end of the flange 550 is preferably done by a subsequent stamping die. One skilled in the art can readily appreciate the particular die shapes required to form the cam-and-drum member 520 as illustrated, and thus detailed illustrations of the particular stamping dies are not being provided. Other methods of forming these structures may also be used.

This cam-and-drum member 520 may be used in the construction of FIGS. 1-9, or any other brake actuator.

While the above description constitutes the preferred embodiments, it will be appreciated that the present invention is susceptible to modification and change without departing from the fair meaning of the proper scope of the accompanying claims.

What is claimed:

1. A brake actuator for applying tension to a brake cable connected to the brake system of a motor vehicle, the actuator comprising:
a mounting bracket;
a brake actuator lever mounted for pivotal movement relative to the mounting bracket in brake applying and brake releasing directions;
a cam-and-drum member mounted for rotation relative to relative to said brake actuator lever, said cam-and-drum member being formed as one integral part including a protruding drum portion and a cam portion integral with the drum portion, the cam portion providing a groove defining a cable guide for receiving the brake cable and enabling winding thereof onto the cam portion; and
a clutch releasably coupling said cam-and-drum member to said brake actuator lever such that said cam-and-drum member rotates with pivotal movement of said brake actuator lever relative to said mounting bracket at least in a brake applying direction relative to said mounting bracket, thereby winding the brake cable onto the cam portion and applying tension to the cable for activating the brake system, said clutch being operable to release said cam-and-drum member from the lever such that said cam-and-drum member is able to rotate relative to said brake actuator lever at least when said lever is in a brake released position;
a spring connected to the cam-and-drum member, said spring biasing said cam-and-drum member in a slack take-up direction corresponding to the brake applying direction relative to said lever to wind the cable thereon for taking up cable slack when said clutch releases said cam-and-drum member from the lever.

2. A brake actuator according to claim 1, wherein said clutch comprises a clutch spring embracing an exterior surface of the drum portion to releasably couple said cam-and-drum member to said brake actuator lever;
a clutch spring release positioned to engage and said clutch spring so as to expand said clutch spring to release said cam-and-drum member from the lever at least when said lever is in a brake released position.

3. An actuator according to claim 2, wherein said cam-and-drum member is a stamped part.

4. A brake actuator for applying tension to a brake cable connected to the brake system of a motor vehicle, the actuator comprising:
a mounting bracket;
a brake actuator lever mounted for pivotal movement relative to the mounting bracket;
a cam member mounted for rotation relative to relative to said brake actuator lever, the cam member providing a groove defining a cable guide for receiving the brake cable and enabling winding thereof onto the cam member, said cam member being formed as one integral part;
a clutch releasably coupling said cam member to said brake actuator lever such that said cam member rotates with pivotal movement of said brake actuator lever relative to said mounting bracket at least in a brake applying direction relative to said mounting bracket, thereby winding the brake cable onto the cam member and applying tension to the cable for activating the brake system, said clutch being operable to release said cam member from the lever such that said cam member is able to rotate relative to said brake actuator lever at least when said lever is in a brake released position; and
a spring connected to the cam member, said spring biasing said cam member in a slack take-up direction relative to said lever to wind the cable thereon for taking up cable slack when said clutch releases said cam member from the lever.

5. An actuator according to claim 4, further comprising:
a spring embraceable structure fixed on the cam member for rotation therewith relative to the brake actuator lever, the spring embraceable structure providing an exterior surface;
said clutch comprising a clutch spring embracing the exterior surface of the spring embraceable structure to releasably couple said spring embraceable structure and said cam member to said brake actuator lever such that said spring embraceable structure and said cam member rotate with pivotal movement of said brake actuator lever relative to said mounting bracket at least in a brake applying direction relative to said mounting bracket; and
a clutch spring release positioned to engage said clutch spring so as to expand said clutch spring to release said spring embraceable structure and said cam member from the lever such that said spring embraceable structure and said cam member are able to rotate relative to said brake actuator lever at least when said lever is in a brake released position.

5. An actuator according to claim 4, wherein said spring embraceable structure is a drum fixed to said cam member.

6. An actuator according to claim 5, wherein said drum is integral as one-piece with said cam member.

7. An actuator according to claim 4, wherein said cam member is a stamped part.

8. A method for forming a brake actuator for applying tension to a brake cable connected to the brake system of a motor vehicle, the method comprising:
forming a piece of sheet metal to initially form a cam member having a flange;
forming said flange into a general U-shape so as to define a cable guide for receiving the brake cable and enabling winding thereof onto the cam member;
providing a mounting bracket;
pivotally mounting a brake actuator lever for pivotal movement relative to the mounting bracket;
rotatably mounting said cam member mounted for rotation relative to said brake actuator lever;
providing a clutch releasably coupling said cam member to said brake actuator lever such that said cam member rotates with pivotal movement of said brake actuator lever relative to said mounting bracket at least in a brake applying direction relative to said mounting bracket, thereby winding the brake cable onto the cam member and applying tension to the cable for activating the brake system, said clutch being operable to release said cam member from the lever such that said cam member is able to rotate relative to said brake actuator lever at least when said lever is in a brake released position; and
connecting a spring to the cam member, said spring biasing said cam member in a slack take-up direction relative to said lever to wind the cable thereon for taking up cable slack when said clutch releases said cam member from the lever.

9. A method according to claim 8, wherein forming the piece of sheet metal to initially form a cam member includes stamping the piece of sheet metal.

10. A method according to claim 9, wherein forming said flange into a general U-shape includes stamping the flange such that said flange extends at an angle from the cam member and then subsequently stamping a free end of said flange to form the flange into the general U-shape.

11. A method for forming a brake actuator for applying tension to a brake cable connected to the brake system of a motor vehicle, the method comprising:
forming a piece of sheet metal to initially form a cam-and-drum member having a flange;
forming said flange into a general U-shape so as to define a cable guide for receiving the brake cable and enabling winding thereof onto the cam portion;
providing a mounting bracket;
pivotally mounting a brake actuator lever for pivotal movement relative to the mounting bracket;
rotatably mounting said cam-and-drum member for rotation relative to said brake actuator lever;
providing a clutch releasably coupling said cam-and-drum member to said brake actuator lever such that said cam-and-drum member rotates with pivotal movement of said brake actuator lever relative to said mounting bracket at least in a brake applying direction relative to said mounting bracket, thereby winding the brake cable onto the cam portion and applying tension to the cable for activating the brake system, said clutch being operable to release said cam-and-drum member from the lever such that said cam-and-drum member is able to rotate relative to said brake actuator lever at least when said lever is in a brake released position; and
connecting a spring to the cam-and-drum member, said spring biasing said cam-and-drum member in a slack take-up direction relative to said lever to wind the cable thereon for taking up cable slack when said clutch releases said cam-and-drum member from the lever.
